(19) United States
(12) Patent Application Publication
(10) Pub. No.: US 2019/0112987 A1
(43) Pub. Date: Apr. 18, 2019

(54) ELECTRIC CRUISE PUMP SYSTEM

(71) Applicant: HAMILTON SUNDSTRAND CORPORATION, Charlotte, NC (US)

(72) Inventors: Morgan O'Rorke, West Hartford, CT (US); Erick Ramos, South Windsor, CT (US); Adrian L. Stoicescu, Roscoe, IL (US)

(21) Appl. No.: 15/785,717

(22) Filed: Oct. 17, 2017

(51) Int. Cl. F02C 9/26; F02C 7/236; F02C 7/232

(52) U.S. Cl. CPC F02C 9/263; F02C 7/236; F02M 37/08; F05D 2220/32; F02C 7/232

(57) ABSTRACT

A fuel supply system for a gas turbine engine has a fuel tank, a main fuel pump for receiving fuel from the fuel tank, and an electric pump also for receiving fuel from the fuel tank. The main fuel pump and the electric pump both deliver fuel to a sharing valve. The sharing valve selectively delivers fuel downstream into a gas generator portion of the gas turbine engine and to an augmentor. A control is programmed to control the sharing valve, such that fuel flows from the main fuel pump to the augmentor, and to the gas generator at higher demand operation, and does not flow from the main fuel pump at lower demand operation. A gas turbine engine and a method are also disclosed.

### BACKGROUND

This application relates to a fuel supply system for use on gas turbine engines on military aircraft applications.

Gas turbine engines are known and typically include a compressor compressing air and delivering it into a combustor. The air is mixed with fuel and ignited in the combustor and products of the combustion pass downstream over turbine rotors, driving them to rotate.

In military applications, gas turbine engines are also provided with an augmentor. An augmentor is typically positioned downstream of the turbine exhaust and receives additional fuel to provide additional combustion to achieve propulsion and very high speed operation.

Modern military jet engines face thermal management concerns. Fuel temperatures are increasing.

Of course, the pumping systems for the fuel supply must be sufficient to meet the greatest demand. For that reason, relatively large pumps have been utilized. At lower demand operation, which is the bulk of the time the aircraft is in operation, the pumped fuel is returned to a fuel tank downstream of the pump. This increases the temperature of the fuel.

### SUMMARY

A fuel supply system for a gas turbine engine has a fuel tank, a main fuel pump for receiving fuel from the fuel tank, and an electric pump also for receiving fuel from the fuel tank. The main fuel pump and the electric pump both deliver fuel to a sharing valve. The sharing valve delivers fuel downstream into a gas generator portion of the gas turbine engine and to an augmentor. A control is programmed to control the sharing valve, such that fuel flows from the main fuel pump to the augmentor, and to the gas generator at higher demand operation, and does not flow from the main fuel pump at lower demand operation.

A gas turbine engine and a method are also disclosed.

These and other features may be best understood from the following drawings and specification.

### BRIEF DESCRIPTION OF THE DRAWINGS

FIG. 1 schematically shows a gas turbine engine.

FIG. 2 schematically shows a fuel supply system for the engine of FIG. 1.

### DETAILED DESCRIPTION

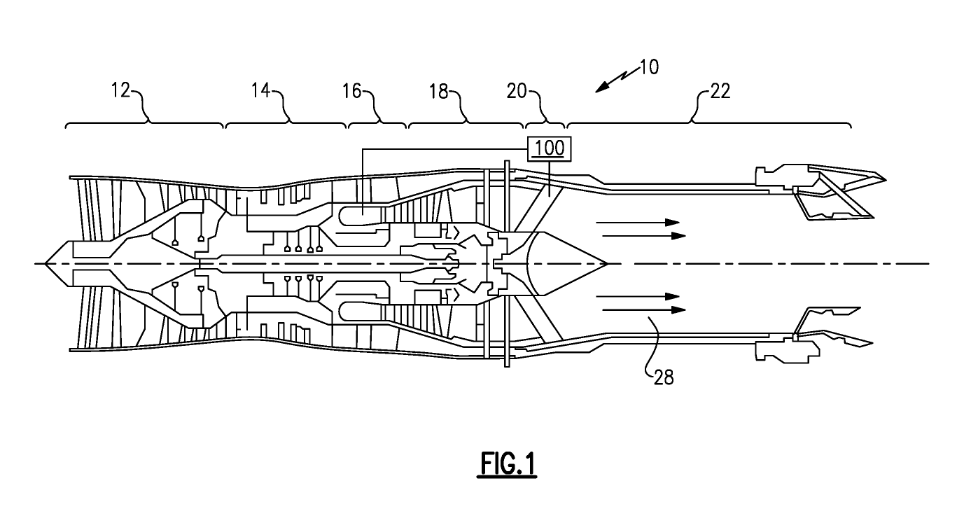

Referring to FIG. 1, a gas turbine engine 10 includes a fan section 12, a compressor section 14, a combustor section 16, and a turbine section 18. Air entering into the fan section 12 is initially compressed and fed to the compressor section 14. In the compressor section 14, the incoming air from the fan section 12 is further compressed and communicated to the combustor section 16. In the combustor section 16, the compressed air is mixed with gas and ignited to generate a hot exhaust stream 28. The hot exhaust stream 28 is expanded through the turbine section 18 to drive the fan section 12 and the compressor section 14.

The gas turbine engine 10 includes an augmenter section 20 where additional fuel can be mixed with the exhaust gasses 28 and ignited to generate additional thrust. The exhaust gasses 28 flow from the turbine section 18 and the augmenter section 20 through an exhaust liner assembly 22. Fuel supply 100 is shown to deliver fuel to the combustor section 16 and augmentor 20.

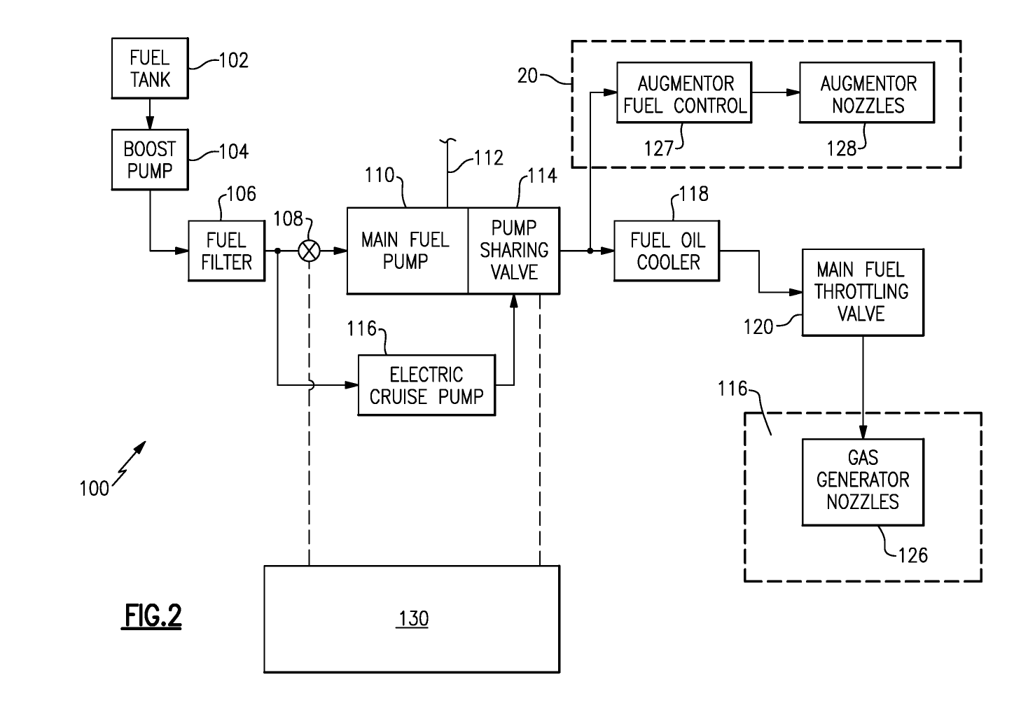

FIG. 2 shows a fuel supply system 100 for the engine shown in FIG. 1. A fuel tank 102 communicates with a boost pump 104, which supplies fuel through a fuel filter 106. A valve 108 downstream of the fuel filter 106 can supply fuel to a main fuel pump 110. Main fuel pump 110 is shown schematically at being driven by a shaft 112, which may be driven by the turbine section of the gas generator illustrated in FIG. 1.

The valve 108 is opened or closed to allow the flow of fuel to the main fuel pump 110. Main fuel pump 110 may be a “run dry” pump, which means that it will continue to run even if fuel is blocked by the valve 108.

The main fuel pump 110 may be a centrifugal pump.

Fuel is also delivered to an electric cruise pump 116. A pump sharing valve 114 combines the flow from the pumps 116 and 110 and supplies it downstream to a fuel oil cooler 118, a main fuel throttling valve 120, and into the gas turbine combustor section 16 and its nozzles 126.

Fuel is also delivered to an augmentor fuel control 127 and to augmentor nozzles 128, selectively in augmentor section 20.

The sharing valve delivers fuel only from the electric pump at certain lower demand operation.

A control 130 controls the valve 108 and the sharing valve 114.

During the bulk of the operation of the engine 122, the fuel supply needs can be met by the electric cruise pump 116. Thus, valve 108 is closed and sharing valve 114 delivers fuel only from electric cruise pump 116. At times when there is greater need for fuels, such as at takeoff, perhaps climb, and in military maneuvering, the pump 110 can supplement, or replace, the flow from the pump 116. Generally at the times when electric cruise pump 116 is delivering fuel on its own, there is no fuel being delivered to said augmentor.

As the shutoff valve 108 opens and the main fuel pump 110 begins to produce flow, the pump sharing valve 114 may begin to shift the supply of flow from the electric cruise pump 116 to pump 110. As the flow required from pump 116 decreases, its speed may be reduced to minimize power extraction until the pump is spinning at a minimum speed or until completely stationary.

A method of operating a gas turbine engine includes the steps of providing a main fuel pump to deliver fuel from a fuel tank, and providing an electric pump to deliver fuel from the fuel tank. The main fuel pump and the electric pump both deliver fuel to a sharing valve. The sharing valve selectively delivers fuel downstream into a gas generator portion of a gas turbine engine and to an augmentor. The sharing valve is controlled such that fuel flows from the main fuel pump to the augmentor and to the gas generator at higher demand operation, and does not flow from the main fuel pump at lower demand operation.

Although an embodiment of this invention has been disclosed, a worker of ordinary skill in this art would recognize that certain modifications would come within the scope of this disclosure. For that reason, the following claims should be studied to determine the true scope and content of this disclosure.

1. A fuel supply system for a gas turbine engine comprising:
a fuel tank;
a main fuel pump for receiving fuel from said fuel tank, and an electric pump also for receiving fuel from said fuel tank, said main fuel pump and said electric pump both delivering fuel to a sharing valve, said sharing valve selectively delivering fuel downstream into a gas generator portion of a gas turbine engine, and to an augmentor; and
a control programmed to control said sharing valve, such that fuel flows from said main fuel pump to the augmentor and the gas generator at higher demand operation, and does not flow from said main fuel pump at lower demand operation.

2. The fuel supply system as set forth in claim 1, wherein a main fuel valve selectively blocks the flow of fuel to said main fuel pump during lower demand operation.

3. The fuel supply system as set forth in claim 1, wherein said main fuel pump and said electric pump, both supply fuel to said augmentor and to said gas generator during higher demand operation.

4. The fuel supply system as set forth in claim 1, wherein fuel being delivered to said augmentor passes through an augmentor fuel control.

5. The fuel supply system as set forth in claim 1, wherein fuel from said fuel tank being driven by a boost pump to said main fuel pump and said electric pump.

6. The fuel supply system as set forth in claim 1, wherein fuel is not delivered to said augmentor during lower demand operation.

7. The fuel supply system as set forth in claim 1, wherein said sharing valve delivers fuel only from said electric pump at certain lower demand operation.

8. The fuel supply system as set forth in claim 1, wherein when said main fuel valve is closed, said main fuel pump continues to run as a run-dry pump.

9. A gas turbine engine comprising:
a gas generator including a compressor, a combustor section and a turbine section, and an augmentor section;
a fuel supply system including a fuel tank;
a main fuel pump for receiving fuel from said fuel tank, and an electric pump also for receiving fuel from said fuel tank, said main fuel pump and said electric pump both delivering fuel to a sharing valve, said sharing valve selectively delivering fuel into said combustor section of said gas generator portion of a gas turbine engine, and to an augmentor; and
a control programmed to control said sharing valve, such that fuel flows from said main fuel pump to the augmentor and the gas generator at higher demand operation, and does not flow from said main fuel pump at lower demand operation.

10. The gas turbine engine as set forth in claim 9, wherein a main fuel valve selectively blocks the flow of fuel to said main fuel pump during lower demand operation.

11. The gas turbine engine as set forth in claim 9, wherein said main fuel pump and said electric pump, both supply fuel to said augmentor and to said gas generator during higher demand operation.

12. The gas turbine engine as set forth in claim 9, wherein a valve selectively blocking the flow of fuel to said main fuel pump during said lower demand operation.

13. The gas turbine engine as set forth in claim 9, wherein said sharing valve delivers fuel only from said electric pump at certain lower demand operation.

14. The gas turbine engine as set forth in claim 9, wherein when said main fuel valve is closed, said main fuel pump continues to run as a run-dry pump.

15. A method of operating a gas turbine engine comprising:
providing a main fuel pump to deliver fuel from a fuel tank, and providing an electric pump to deliver fuel from said fuel tank, said main fuel pump and said electric pump both delivering fuel to a sharing valve, said sharing valve selectively delivering fuel downstream into a gas generator portion of said gas turbine engine and to an augmentor; and
controlling said sharing valve such that fuel flows from said main fuel pump to said augmentor and to said gas generator at higher demand operation, and does not flow from said main fuel pump at lower demand operation.

16. The method of operating a gas turbine engine as set forth in claim 15, wherein a valve selectively blocking the flow of fuel to said main fuel pump during said lower demand operation.

17. The method of operating a gas turbine engine as set forth in claim 16, wherein fuel being delivered to said augmentor passes through an augmentor fuel control, which can selectively block flow.

18. The method as set forth in claim 15, wherein fuel is not delivered to said augmentor during lower demand operation.

19. The method as set forth in claim 15, wherein said sharing valve delivers fuel only from said electric pump at certain lower demand operation.

20. The method as set forth in claim 15, wherein when said main fuel valve is closed, said main fuel pump continues to run as a run-dry pump.
